(19) United States
(12) Patent Application Publication
(10) Pub. No.: US 2017/0373988 A1
(43) Pub. Date: Dec. 28, 2017

(54) SYSTEMS FOR PROACTIVE MODIFICATION OF RESOURCE UTILIZATION AND DEMAND

(71) Applicant: NAV TECHNOLOGIES, INC., Draper, UT (US)

(72) Inventors: Hadley Soffe, Salt Lake City, UT (US); Caton Hanson, South Jordan, UT (US); Jesse Harding, South Jordan, UT (US); Levi King, South Jordan, UT (US)

(21) Appl. No.: 15/700,567

(22) Filed: Sep. 11, 2017

Related U.S. Application Data
(63) Continuation-in-part of application No. 14/826,192, filed on Aug. 13, 2015.
Application No. 14/826,192 is a continuation-in-part of application No. 13/785,984, filed on Mar. 5, 2013, now abandoned.
Application No. 13/785,984 is a continuation-in-part of application No. 13/713,743, filed on Dec. 13, 2012, now abandoned.
Application No. 13/713,743 is a continuation-in-part of application No. 14/085,724, filed on Nov. 20, 2013, now abandoned.
Application No. 14/085,724 is a continuation-in-part of application No. 13/785,984, filed on Mar. 5, 2013, now abandoned.
Application No. 13/785,984 is a continuation-in-part of application No. 13/713,743, filed on Dec. 13, 2012, now abandoned.
(60) Provisional application No. 62/533,580, filed on Jul. 17, 2017.
(60) Provisional application No. 62/036,625, filed on Aug. 13, 2014.

(51) Int. Cl. H04L 12/911; H04L 12/927

(52) U.S. Cl. CPC H04L 47/823; H04L 47/803

(57) ABSTRACT

Computer systems and computer-implemented methods for determining a likelihood an application will exceed one or more of a resource utilization threshold or a resource demand threshold include receiving data for a plurality of applications, and based on the received data, determining one or more of a resource utilization or a resource demand for at least a subset of applications of the plurality of applications. A method additionally includes identifying a pattern from the received data, the pattern being associated with one or more of the resource utilization or the resource demand for the subset of applications, and based on the pattern, determining one or more of a resource utilization threshold or a resource demand threshold. A method can further include determining a likelihood the application will exceed one or more of the resource utilization threshold or the resource demand threshold.

### CROSS-REFERENCE TO RELATED APPLICATIONS

This application claims priority to and the benefit of United States Provisional Patent Application No. 62/533,580, filed Jul. 17, 2017 and titled “SYSTEMS FOR PROACTIVE MODIFICATION OF RESOURCE UTILIZATION AND DEMAND.”

This application is a continuation-in-part of pending U.S. patent application Ser. No. 14/826,192, filed Aug. 13, 2015, entitled “CREDIT SCORING BASED ON PERSONAL AND BUSINESS FINANCIAL INFORMATION,” which claims priority to and the benefit of United States Provisional Application No. 62/036,625, filed Aug. 13, 2014, entitled, “CREDIT INFORMATION SCORING AND DELIVERY,” and which is a continuation-in-part of U.S. patent application Ser. No. 13/785,984 filed Mar. 5, 2013, entitled “SINGLE POINT SIGN UP AND ACCESS TO PERSONAL AND BUSINESS CREDIT INFORMATION” and of U.S. patent application Ser. No. 13/713,743 filed Dec. 13, 2012, entitled “PROVIDING COMBINED ACCESS TO BUSINESS AND PERSONAL CREDIT INFORMATION”.

This application is a continuation-in-part of pending U.S. patent application Ser. No. 14/085,724 filed Nov. 20, 2013, entitled “COMBINED PRESENTATION OF CREDIT INFORMATION,” which is a continuation-in-part of U.S. patent application Ser. No. 13/785,984 filed Mar. 5, 2013, entitled “SINGLE POINT SIGN UP AND ACCESS TO PERSONAL AND BUSINESS CREDIT INFORMATION” and of U.S. patent application Ser. No. 13/713,743 filed Dec. 13, 2012, entitled “PROVIDING COMBINED ACCESS TO BUSINESS AND PERSONAL CREDIT INFORMATION”.

The foregoing disclosures are incorporated herein in their entirety.

### BACKGROUND

Understanding resource utilization and resource demands of components within a system is useful. It can, for example, help systems to perform efficiently and prevent operational failures. In systems where the components are well defined or where the components include a static demand for system resources, allocating system resources to meet the various resource utilization requirements of each component is predictable. Further, if a component has a known, static demand for system resources that is greater than the system can provide, it is more evident that the component cannot be supported by the system and incorporating the component within the system can be avoided, thereby preventing inevitable operational failures. Alternatively, the system itself can be upgraded to provide the additional resources required to support the previously incompatible component.

However, in systems where even a single component has dynamic demands for resources, it can be difficult to predict or determine whether the system can support the single component, and in some instances, it can even threaten the operational reliability of the entire system. These problems are compounded when a system includes multiple components that have dynamic demands for resources and the system has a finite or static capacity. An increase or spike in resource demand from a single component can cause an operational failure. For example, the operational failure can be solely at the petitioning component, with the system denying its request. Alternatively, the operational failure can be at another component within the system, with the system granting the increased resource utilization request to the petitioning component, leaving an insufficient amount of resources for another component to operate. In some instances, the resource demands of system components may become so great that the system fails altogether.

Accordingly, there is an ongoing need for improved systems for predicting, and in some cases modifying, resource utilization and demands.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that are further described below in the Detailed Description. This Summary is not intended to identify key features or essential features of the claimed subj ect matter, nor is it intended to be used as an aid in determining the scope of the claimed subject matter.

Embodiments of the present disclosure include systems, methods, and computer program products for predicting, and in some cases modifying, resource utilization and demands.

One or more embodiments include a computer system having processor(s) and computer-readable storage media having stored thereon computer-executable instructions that when executed by the processor(s) cause the computer system to determine a likelihood an application will exceed one or more of a resource utilization threshold or a resource demand threshold by causing the computer system to (i) receive data for a plurality of applications; (ii) based on the received data, determine one or more of a resource utilization or a resource demand for at least a subset of applications of the plurality of applications; (iii) identify a pattern from the received data, the pattern being associated with one or more of the resource utilization or the resource demand for the subset of applications; (iv) based on the pattern, determine one or more of a resource utilization threshold or a resource demand threshold; and (v) determine a likelihood the application will exceed one or more of the resource utilization threshold or the resource demand threshold.

In some embodiments, the determining a likelihood the application will exceed one or more of the resource utilization threshold or the resource demand threshold includes (i) identifying one or more application properties from the received data, the one or more application properties being derived from a subset of the plurality of applications having a history of exceeding one or more of the resource utilization threshold or the resource demand threshold; (ii) identifying one or more patterns based on the one or more application properties; and (iii) detecting the application having an increase in a frequency or number of application properties associated with the one or more patterns.

One or more implementations of the present disclosure include a computer-implemented method for determining a likelihood an application will exceed one or more of a resource utilization threshold or a resource demand threshold. The method includes receiving data for a plurality of applications, and based on the received data, determining one or more of a resource utilization or a resource demand for at least a subset of applications of the plurality of applications. The method additionally includes identifying a pattern from the received data, the pattern being associated with one or more of the resource utilization or the resource demand for the subset of applications, and based on the pattern, determining one or more of a resource utilization threshold or a resource demand threshold. The method additionally includes determining a likelihood the application will exceed one or more of the resource utilization threshold or the resource demand threshold.

In some embodiments, determining the likelihood the application will exceed one or more of the resource utilization threshold or the resource demand threshold includes (i) identifying one or more application properties from the received data, the one or more application properties being derived from a subset of the plurality of applications having a history of exceeding one or more of the resource utilization threshold or the resource demand threshold; (ii) identifying one or more patterns based on the one or more application properties; and (iii) detecting the application having an increase in a frequency or number of application properties associated with the one or more patterns.

In some embodiments, the computer system includes computer-executable instructions that when executed further cause the computer system to generate an incentive in response to detecting the application having the increase in the frequency or number of application properties associated with the patterns. In some embodiments, the system can additionally be configured to apply the incentive to the application and/or report the incentive to a user.

One or more embodiments include a computer system having processor(s) and computer-readable storage media having stored thereon computer-executable instructions that when executed by the processor(s) cause the computer system to determine a likelihood an application will exceed one or more of a resource utilization threshold or a resource demand threshold by causing the computer system to (i) receive data for a plurality of applications; (ii) from the received data, identify a resource utilization pattern for the plurality of applications; (iii) based on the pattern, determine a resource utilization threshold; (iv) determine one or more application properties associated with a subset of the plurality of applications having a history of exceeding the resource utilization threshold; (v) determine a number or frequency of the one or more application properties being associated with the application; and (vi) determine a likelihood the application will exceed the resource utilization threshold.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above recited and other advantages and features of the disclosure can be obtained, a more particular description of the disclosure briefly described above will be rendered by reference to specific embodiments thereof, which are illustrated in the appended drawings. It is appreciated that these drawings depict only typical embodiments of the disclosure and are not therefore to be considered to be limiting of its scope. The disclosure will be described and explained with additional specificity and detail through the use of the accompanying drawings in which:

FIG. 1 illustrates a schematic representation of a computing system, according to one or more embodiments of the present disclosure.

FIG. 2 illustrates a schematic representation of a computing system for determining a likelihood a user will exceed a threshold, according to one or more embodiments of the present disclosure.

FIG. 3 illustrates a schematic representation of a computing system for identifying a pattern, according to one or more embodiments of the present disclosure.

FIG. 4 illustrates another schematic representation of a computing system for identifying a pattern and for identifying a likelihood of exceeding a threshold, according to one or more embodiments of the present disclosure.

FIG. 5 illustrates a method for determining a likelihood an application will exceed a threshold.

FIG. 6 illustrates another method for determining a likelihood an application will exceed a threshold.

FIG. 7 illustrates a yet another method for determining a likelihood an application will exceed a threshold.

### DETAILED DESCRIPTION

Embodiments of this disclosure include systems, methods, and computer program products for predicting, and in some cases modifying, resource utilization and demands. In some embodiments, this can include proactively modifying an application based on a likelihood the application will exceed a resource utilization threshold and/or a resource demand threshold. Technical advantages of the embodiments and implementations of the present invention should be apparent and are found throughout the disclosure. Nonetheless, some additional and/or reiterated advantages are set forth below, which are not intended to limit the scope of the disclosed embodiments or to be an exhaustive enumeration of every advantage of the present invention. It should be appreciated that some advantages, whether or not specifically enumerated, are inherent to implementations of the present invention and can be observed by practicing one or more embodiments thereof

Implementations of the present disclosure provide improvements to the operation of computing systems, particularly with respect to improvements to the operation of servers, hypervisors, or other computer systems that manage and/or monitor resource utilization. For example, one advantage/improvement provided by implementations of the present disclosure includes an increased efficiency determining, predicting, and/or increasing operational reliability of one or more users (e.g. applications, components, computing systems, etc.). Additionally, or alternatively, by identifying and/or modifying those users that are likely to exceed a given threshold, embodiments of the present disclosure can positively affect computational costs.

Further, embodiments of the present disclosure reduce the amount of oversight by network administrators. In some embodiments, if a database server routinely fails to allocate resources or predict resource demands, it is likely that the database server will be running inefficiently or failing altogether. Typically, an administrator would be required to troubleshoot the problem and manually identify the offending user(s)/component(s) followed by throttling and/or eliminating the offending user(s) and/or throttling and/or upgrading the offending component(s). This process can severely hamper the productivity of a computer system, including database servers. Practicing embodiments of the present disclosure reduces the likelihood that computer systems will experience operational failures because the associated user(s)/component(s) will be paired with computer systems that have a high likelihood of successful operation together. This reduces the need for administrators' intervention and significantly increases the productivity of a computer system (e.g., a database server). Further, the predictive power enabled by practicing embodiments of the present disclosure can allow administrators to more accurately predict future needs and/or preemptively eliminate potential bottlenecks or other inefficiencies that could arise from future computer system conditions.

The methods disclosed herein are implemented by one or more computing system. It will be appreciated that computing systems are increasingly taking a wide variety of forms. Computing systems may, for example, be handheld devices, appliances, laptop computers, desktop computers, mainframes, distributed computing systems, datacenters, or even devices that have not conventionally been considered a computing system, such as wearables (e.g., glasses). In this description and in the claims, the term “computer system” or “computing system” is defined broadly as including any device or system—or combination thereof—that includes at least one physical and tangible processor and a physical and tangible memory capable of having thereon computer-executable instructions that may be executed by a processor. The memory may take any form and may depend on the nature and form of the computing system. A computing system may be distributed over a network environment and may include multiple constituent computing systems.

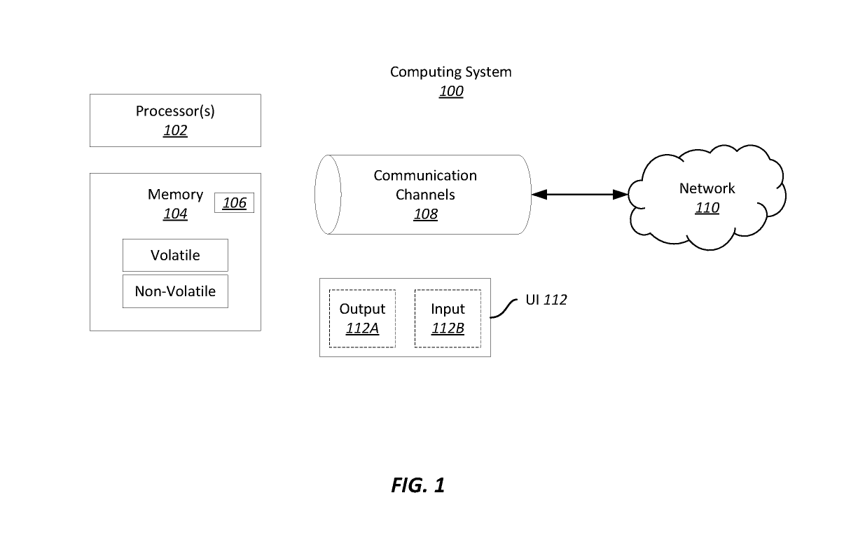

As illustrated in FIG. 1, in its most basic configuration, a computing system 100 typically includes at least one hardware processing unit 102 and memory 104. The memory 104 may be physical system memory, which may be volatile, non-volatile, or some combination of the two. The term “memory” may also be used herein to refer to non-volatile mass storage such as physical storage media. The computing system 100 may be a standalone or distributed system. If the computing system is distributed, the processing, memory, and/or storage capability may be distributed as well.

Any number and/or type of general purpose or special purpose computing systems described above can be configured to predict and/or modify resource utilization and demands. For example, the database(s) may be stored in the memory 104 of computing system 100, and for the purpose of this disclosure, any general purpose or special purpose computer storing at least a portion of one or more databases will be generally referred to as a database server. It should be appreciated, however, that the term “database server” as used herein should also be understood to include the back-end system of a database application that performs tasks such as data analysis, storage, data manipulation, archiving, and other non-user specific tasks.

The computing system 100 also has thereon multiple structures often referred to as an “executable component.” For instance, the memory 104 of the computing system 100 is illustrated as including executable component 106. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media.

The structure of the executable component exists on a computer-readable medium in such a form that it is operable, when executed by one or more processors of the computing system, to cause the computing system to perform one or more function, such as the functions and methods described herein. Such a structure may be computer-readable directly by the processors—as is the case if the executable component were binary. Alternatively, the structure may be structured to be interpretable and/or compiled—whether in a single stage or in multiple stages—so as to generate such binary that is directly interpretable by the processors. Such an understanding of exemplary structures of an executable component is well within the understanding of one of ordinary skill in the art of computing when using the term “executable component.”

The term “executable component” is also well understood by one of ordinary skill as including structures that are implemented exclusively or near-exclusively in hardware, such as within a field programmable gate array (FPGA), an application specific integrated circuit (ASIC), Program-specific Standard Products (ASSPs), System-on-a-chip systems (SOCs), Complex Programmable Logic Devices (CPLDs), or any other specialized circuit. Accordingly, the term “executable component” is a term for a structure that is well understood by those of ordinary skill in the art of computing, whether implemented in software, hardware, or a combination. In this description, the terms “component,” “service,” “engine,” “module,” “control,” “generator,” or the like may also be used. As used in this description and in this case, these terms—whether expressed with or without a modifying clause—are also intended to be synonymous with the term “executable component,” and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data.

The computer-executable instructions (and the manipulated data) may be stored in the memory 104 of the computing system 100. Computing system 100 may also contain communication channels 108 that allow the computing system 100 to communicate with other computing systems over, for example, network 110.

While not all computing systems require a user interface, in some embodiments the computing system 100 includes a user interface 112 for use in interfacing with a user. The user interface 112 may include output mechanisms 112A as well as input mechanisms 112B. The principles described herein are not limited to the precise output mechanisms 112A or input mechanisms 112B as such will depend on the nature of the device. However, output mechanisms 112A might include, for instance, speakers, displays, tactile output, holograms, and so forth. Examples of input mechanisms 112B might include, for instance, microphones, touchscreens, holograms, cameras, keyboards, mouse, or other pointer input, sensors of any type, and so forth.

Accordingly, embodiments described herein may comprise or utilize a special purpose or general-purpose computing system. Embodiments described herein also include physical and other computer-readable media for carrying or storing computer-executable instructions and/or data structures. Such computer-readable media can be any available media that can be accessed by a general purpose or special purpose computing system. Computer-readable media that store computer-executable instructions are physical storage media. Computer-readable media that carry computer-executable instructions are transmission media. Thus, by way of example—not limitation—embodiments of the invention can comprise at least two distinctly different kinds of computer-readable media: storage media and transmission media.

Computer-readable storage media include RAM, ROM, EEPROM, solid state drives (“SSDs”), flash memory, phase-change memory (“PCM”), CD-ROM or other optical disk storage, magnetic disk storage or other magnetic storage devices, or any other physical and tangible storage medium which can be used to store desired program code in the form of computer-executable instructions or data structures and which can be accessed and executed by a general purpose or special purpose computing system to implement the disclosed functionality of the invention.

Transmission media can include a network and/or data links which can be used to carry desired program code in the form of computer-executable instructions or data structures and which can be accessed and executed by a general purpose or special purpose computing system. Combinations of the above should also be included within the scope of computer-readable media.

Further, upon reaching various computing system components, program code in the form of computer-executable instructions or data structures can be transferred automatically from transmission media to storage media (or vice versa). For example, computer-executable instructions or data structures received over a network or data link can be buffered in RAM within a network interface module (e.g., a “NIC”) and then eventually transferred to computing system RAM and/or to less volatile storage media at a computing system. Thus, it should be understood that storage media can be included in computing system components that also—or even primarily—utilize transmission media.

Although the subject matter described herein is provided in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, tablets, mobile telephones, PDAs, pagers, routers, switches, datacenters, wearables (e.g., glasses) and the like. The invention may also be practiced in distributed system environments where local and remote computing systems, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

### Computing Systems For Characterizing Application Data And/Or User Populations

As provided above, understanding resource utilization and resource demands of components within a system can be useful. It can, for example, help systems to perform efficiently and prevent operational failures. In systems where even a single component has dynamic demands for resources, it can be difficult to predict or determine whether the system can support the single component, and in some instances, it can even threaten the operational reliability of the entire system. These problems are compounded when a system includes multiple components that have dynamic demands for resources and the system has a finite or static capacity. An increase or spike in resource demand from a single component can cause an operational failure or at least threaten operational homeostasis.

For example, a system can deny a user request for additional resources, causing an operational failure with the user. As an additional example, a system can grant an application's request for additional resources resulting in an insufficient amount of available resources for the operation of another application within the system and thereby causing an operational failure with the other application. In some instances, the resource demands of system components may increase over time and become so great that the system cannot support the components simultaneously, causing the system to fail altogether.

Embodiments of the present disclosure enable computing systems to identify properties and characteristics of users (e.g., applications, components, etc.) and to subsequently identify patterns related thereto. The identified patterns can be used for myriad purposes, including, for example, identifying related applications, identifying and/or preparing for future resource demands and/or resource utilization requests, predicting a likelihood an application will exceed a resource demand and/or resource utilization threshold, targeting applications for additional services and/or resources, identifying applications to be transitioned between application silos, and/or reserving resources for applications having the highest likelihood of successfully operating within the system.

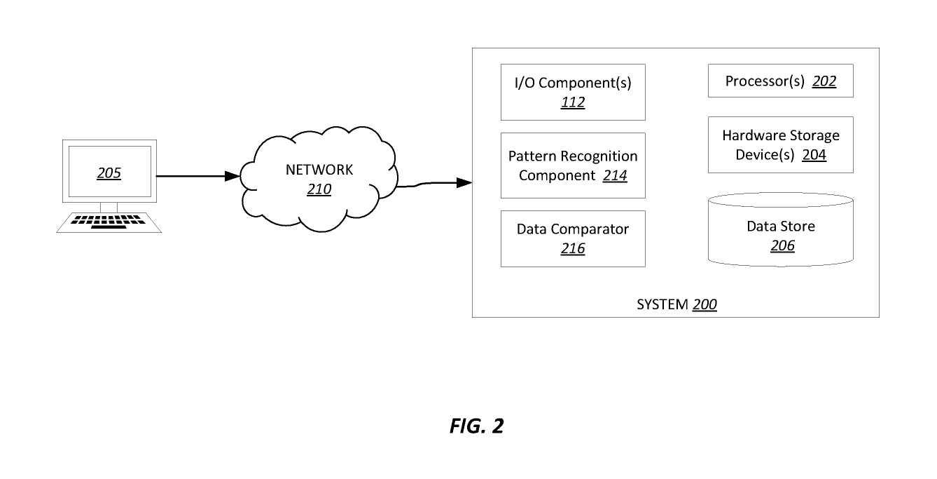

For example, as shown in FIG. 2, a system 200 can interact with a user 205. In some embodiments, the user 205 is an application, a system component, or another system. The user 205 can communicate with the system 200 through network 210. As described herein the network 210 can be a closed network (e.g., a firewalled local area network) or an open network (e.g., the internet). The system 200 can include a data store 206 that includes historical data from a plurality of other users, and by using a pattern recognition component 214, properties and characteristics from users within the data store 206 can be used to identify patterns related thereto. For example, pattern recognition component 214 can identify a set of properties or characteristics exemplified by previous users that successfully operated within the system 200. The data comparator 216 can identify characteristics and properties of the user 205 and compare those identified characteristics and properties with the identified patterns. Based on the comparison, the user 205 can be correlated with one or more groups of previous users, and a likely outcome can be determined therefrom.

In some embodiments, a likely outcome can include a likelihood of exceeding a threshold, such as a resource utilization threshold or resource demand threshold. The system 200 can have a finite amount of resources, and in some embodiments, it is desirous to maximize resource utilization while not causing operational failure within the system generally or with any one or more users of the system. Additionally, or alternatively, it can be beneficial to have sufficient resources within the system 200 such that resources can be allocated to ensure capacity and operation for all known components at any given time. Accordingly, a resource utilization threshold can represent an upper and/or lower bound on the amount of resources to be utilized by any given user of the system 200. For example, a user may be required to meet certain specifications and consistent utilization of resources to operate within the system, or alternatively, the user may be required to not fall below certain specifications and resource utilization requirements.

For example, an application may require a defined number (or range) of computing cycles per second and a defined amount (or range) of volatile memory when executing its processes. To ensure sufficient resources are available within the computer system to host or run the application, the application may be associated with a resource utilization threshold indicating a maximum and/or minimum amount of processing cycles and/or data storage to support the application. In some embodiments, the resource utilization threshold allows the computer system (or an administrator) the ability to determine whether the computer system has sufficient resources available to service/support any given application alone or any subset (or all) of the applications together.

Implementations of the foregoing include, for example, a server hosting a plurality of virtual machines that are each associated with a single user. The virtual machines can each be partitioned a subset of the server's resources, and in some embodiments, the amount of resources partitioned can be dependent upon the user account. For example, user A may only require a word processor and a web browser, whereas user B may require a word processor, a web browser, a graphic design application, and a media player. By implementing a resource utilization threshold, an administrator (or the server) can determine a maximum and/or minimum resource utilization requirement for users A and B. As can be expected, user A may have a lower resource utilization threshold compared to user B, and server resources can be partitioned given each resource utilization threshold.

Additionally, the foregoing resource utilization threshold may be used to determine whether an additional user (e.g., virtual machine) can be supported by the server. For example, the combined resource utilization thresholds of user A and user B can provide an estimate of the amount of computing resources available on the server. By determining a resource utilization threshold for an additional user—user C—the server (or administrator) can determine whether user C can be supported in addition to users A and B. Additionally, or alternatively, this information can be used to determine whether the server's computing resources need to be updated given the number or types of users (e.g., applications) that need to be supported. If the combined resource utilization thresholds of its users exceeds the server's resources, a failure is likely to result, particularly if the resource utilization threshold is set at the minimum resource utilization requirements for each user.

In some embodiments, the resource utilization threshold is determined using one or more of a present resource utilization of one or more users, the average resource utilization of one or more users, a resource utilization history for the one or more users (e.g, the time associated with resource utilization, a proportion of resources utilized, a type of resource utilized, etc.), or a future predicted resource utilization. For example, a resource utilization threshold can be based on the average resource utilization. In the case of user B, above, user B may require a higher total amount of resources given the applications required, but user B may only access two applications at a time based on historical resource utilization data. Accordingly, the resource utilization threshold for user B may be adjusted given historic resource utilization trends. Additionally, or alternatively, user B may only utilize the web browser and media player at night while the word processor and graphic design application are used during the day. Resource utilization may thus be a fluid concept subject to changes based on the time of day, day of the week/month, season, or similar temporal correlations.

Similarly, a resource demand threshold can be determined, which in some embodiments is a threshold or limit on a user's resource utilization. For example, the system 200 can determine a resource demand threshold for the user 205. The resource demand threshold can be based upon the number and/or type of components or users serviced by system 200, available resources, etc. In some embodiments, the resource demand threshold sets an upper and/or lower bound to the amount and/or frequency of resources that can be requested by an individual or set of users. The pattern recognition component 214 and data comparator 216 can be implemented within system 200, as provided above with respect to the resource utilization threshold, to determine the likelihood that the user 205 will exceed a resource demand threshold.

Based on the threshold(s), the system 200 can advantageously identify a likelihood that a user 205 will exceed a resource utilization threshold or a resource demand threshold, and based on that likelihood, the system 200 can provide resources to the user 205 or refrain from doing so. In some embodiments, the system 200 can provide additional resources to the user 205 based on a likelihood the user will exceed one or more thresholds and may balance system resources by offsetting resource utilization/demands (temporally or physically) between users depending on the user's respective thresholds.

In some embodiments, either or both of the pattern recognition component 214 and the data comparator 216 can be a hardware processor, a software processor, or a combination of a hardware and software processor that are configured to perform at least the particular functions attributed herein. As may be the case with the pattern recognition component 214 and/or the data comparator 216—in addition to any other component or module disclosed herein—each component particularly disclosed within their respective system can be a specialized, individual hardware and/or software component (e.g., a single processor for each module), or alternatively, each component can describe functionality attributable to part of a hardware and/or software component (e.g., a single processor configured to perform the functions of multiple modules/components), as known in the art.

It should be appreciated that the same foregoing issues and implementations that were described for computing system 200 can also generally apply to other systems, such as, for example, credit reporting systems, asset utilization systems, credit lending systems, etc. For example, similar to the computer systems described above, a bank or other lending institution may have a finite amount of resources and may have clients with an unknown future demand for credit and/or resource utilization. Being able to predict the credit demands and/or resource utilization needs of each client can help the institution to better manage its resources and expectations without failing. Additionally, or alternatively, understanding the future credit/resource needs of clients can help the institution to better prepare for the future needs and/or to better service the clients, and based on that likelihood, the system 200 can associate with and/or engage the user 205 or refrain from doing so.

Further, although FIGS. 1-4 illustrate computer systems, it should be appreciated that embodiments disclosed herein can additionally be applied to an individual or entity having a present or future need for additional resources. In some embodiments, the resources, thresholds, or other properties and characteristics can be defined within a credit monitoring, reporting, and/or lending service. Users (e.g., individuals, entities, banks, lending institutions, etc.) can implement embodiments described herein to qualify for better rates and/or terms or to identify users that qualify for better rates and/or terms. For example, embodiments of the present disclosure can enable an individual or entity to identify properties and characteristics of other individuals or entities that have successfully acquired an increase in resources, identify patterns and commonalities within those successful individuals or entities—and in some embodiments contrast those patterns, properties, and/or characteristics with patterns, properties, and/or characteristics of unsuccessful individuals or entities—to identify a likelihood that the individual or entity will be successful (e.g., not default on or exceed their credit limits or other resource-based obligations).

Thus, the problems associated with understanding computational resource utilization and demand within a computer system can apply to credit usage, worthiness, or other related aspect associated with individuals, businesses, banks, lending institutions, etc. Similarly, systems and methods disclosed herein for addressing the foregoing problems can apply to computing systems, as disclosed herein, as well as to individuals, businesses, banks, lending institutions, or similar navigating the credit system (e.g., issuing credit, requesting credit, improving your credit score, identifying a likelihood of default, etc.) and/or managing user acquisition, retention, and/or advancement.

As a non-limiting example, an applicant can present with a need for credit, and based on information received regarding the user's resources and credit worthiness [e.g., number and type of revolving secured and unsecured accounts, the frequency of on-time payments, the age of each associated account, an amount of resources requested/required, a type of resources requested/required (e.g., cash, general unsecured open to buy credit increase, obligation to fund operating costs for fulfilling purchase orders, purchase money security interest, mortgage, etc.), available collateral, etc.], the computer system can identify a resource utilization threshold and/or resource demand threshold for the applicant. Similar to that described above, the determined thresholds can be used to determine a likelihood the applicant is going to exceed the thresholds (e.g., likely to default) or if the applicant is likely not to exceed the thresholds (e.g., likely to responsibly handle allocated resources). Such a determination can be used as a factor in the decision to allocate additional resources to the applicant. This can be beneficial to the institution or other entity or individual lending resources, as it can increase the efficiency and/or rate of return on investment and minimize instances where resources are provided to applicants with a high likelihood of defaulting—which can concomitantly cause an operational failure in the lending entity or individual.

It should be appreciated that the applicant's likelihood for exceeding a threshold can be compared to a probability distribution of likelihoods that a threshold will be exceeded, and based on, for example, the applicant's position on the distribution, the decision to lend or remit additional resources can be made. For example, if the applicant's likelihood of exceeding a threshold falls on the distribution above the mean, the applicant's petition for additional resources may be refused. In some embodiments, the applicant's likelihood of exceeding the threshold should fall at least one standard deviation from the norm for the request to be granted. In some implementations, the likelihood should fall at least two standard deviations from the norm. In some embodiments, the likelihood can fall higher on the distribution and the higher likelihood of default may be offset by another applicant with a lower likelihood or may be associated with an increase in rates, a shorter duration for repayment, or a requirement for higher valued collateral.

### Systems For Identifying Patterns Within User Populations

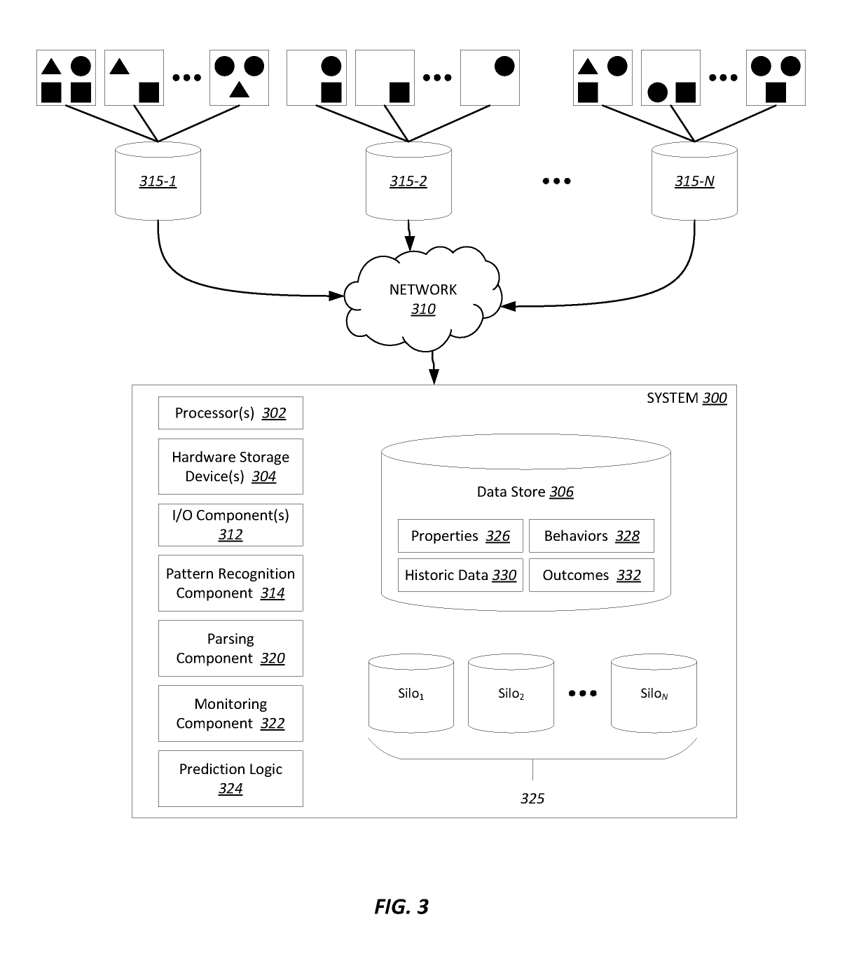

Referring now to FIG. 3, illustrated is a schematic representation of a computer system 300. It should be appreciated that the computer system 300 is in many ways similar to the computer systems of preceding FIGS. 1 and 2 and can implement the same or similar functionalities described above. Additionally, the computer system 300 of FIG. 3 is enabled to identify patterns within a user or user population and/or to determine a likelihood a user will perform similarly to related users.

For example, as illustrated in FIG. 3, a plurality of applications can be associated with one or more data stores and/or computing systems 315-1, 315-2, 315-N, the applications being illustrated as a box having one or more symbols (e.g., square, circle, and tringle). The symbols associated with each application are representative of various application properties, values, and/or characteristics. The computer system 300 can communicate with the data stores and/or computing systems 315-1, 315-2, 315-N through a network 315 and stored within data store 306. As shown, the data stored within data store 306 can be parsed into one or more categories (e.g., application properties 326, application behaviors 328, historic data 330, and outcomes 332).

For example, application properties 326 and/or behaviors 328 can include a logon event, a number or frequency of received communications, a number or frequency of requested communications, an amount and/or length of time the application has been associated with a resource or set of resources, etc. The historic data 330 can include a history of resource utilization, a number and/or frequency of resource requests, a number and/or frequency of occurrences where the application exceeded a resource utilization threshold and/or resource demand threshold, etc. The outcomes 332 can include whether a resource request was approved or denied, a response to exceeding the one or more thresholds, results derived from applying one or more action items to increase a likelihood the application exceeds or fails to exceed a given threshold, etc.

In some embodiments, the data store 306 is a relational database that is configured to associate one or more of the foregoing categories with an application or set of applications.

In some embodiments, the system 300 can utilize the pattern recognition component 314 to identify patterns within the plurality of applications (or from the data within data store 306), predict likelihoods of succeeding or failing (e.g., using prediction logic 324) and associate subsets thereof with one or more application silos 325. For example, applications having a high likelihood of exceeding a resource utilization threshold or which represent more volatile, unpredictable behaviors can be associated with a first silo, Silo-1. Applications having a moderate likelihood of exceeding a resource utilization threshold or which have a few instances of unpredictable behavior can be associated with a second silo, Silo-2. A most reliable set of applications or applications having a lowest likelihood of exceeding a resource utilization threshold can be associated with some additional silo, Silo-N.

The computer system 300 can monitor (e.g., using monitoring component 322) one or more additional applications and identify and/or parse properties of the application using parsing component 320. The computer system can then identify patterns within the application (e.g., using the pattern recognition component 314) as they relate to one or more previously identified patterns for other applications. The prediction logic 324 can then predict the likelihood an event will occur based on the properties and patterns identified in the application.

For example, by observing historical examples of users that petitioned for additional resources and succeeded (however success is measured by the system—e.g., did not exceed a current or updated resource utilization threshold, did not individually fail or contribute to failure of the system, etc.). Attributes of the successful (and in some embodiments the unsuccessful) are parsed and patterns identified therefrom that can be used as a model for predicting whether a new user will succeed within the given system. In some embodiments, the number and/or set of properties matching the new user and the properties associated with one or more success models can contribute to the likelihood of success attributed to the new user.

As a particular, non-specific example of the foregoing, the system 300 of FIG. 3 can be adapted to identify users (e.g., applications, components, individuals. or entities) that have a low likelihood for exceeding a threshold (e.g., a resource utilization threshold) based on properties associated with other users having a low likelihood for exceeding a threshold. That is, based on attributes and/or behaviors for a plurality of users that have been previously associated with the system—and patterns drawn therefrom—the prediction logic 324 of the system 300 can be enabled to determine a likelihood the user will exceed a threshold. In some embodiments, the properties may include an average or mean resource availability, a historic maximum resource utilization, a frequency and timing of resource utilization, a historic resource demand (e.g., highest resource demand, average resource demand, frequency of resource demands, etc.), etc.

In some embodiments, the users having volatile attributes are rewarded additional resources. This may decrease the frequency or number of system failures by insulating resource demands of volatile users.

Alternatively, users having stable attributes can be rewarded additional resources. That is, in some embodiments, users that demonstrate responsible, stable, and/or consistent resource utilization may be provided with additional resources. In such instances, these users may be able to expand the work or number/type of applications that can be run and are likely to do so in a predictable manner. The predictability of these users benefits the system by enabling the system to run with less risk of failing and may additionally benefit the system by allowing the system to allocate additional, unused resources to other users with confidence that resource utilization requests from all users are likely to be granted without causing a system/user failure. Compared to instances where volatile users are provided additional resources, providing additional resources to stable users allows the system to more efficiently leverage its resources. For example, a volatile user may only use 10% of the allocated resources 95% of the time, but 5% of the time, the volatile user sporadically uses 95% of the allocated resources. This variable resource utilization makes it difficult to withdraw resources that are otherwise unused 95% of the time. On the other hand, if a user utilizes 70% of the allocated resources 95% of the time and 75% of allocated resources the remaining 5% of the time, it is more predictable to either reallocate the additional, unused resources or to increase the allocation of resources to this user so additional processes can be implemented or so that the currently running processes can do so more efficiently.

### Systems For Determining A Likelihood Of Exceeding A Threshold And For Generating Actions Related Thereto

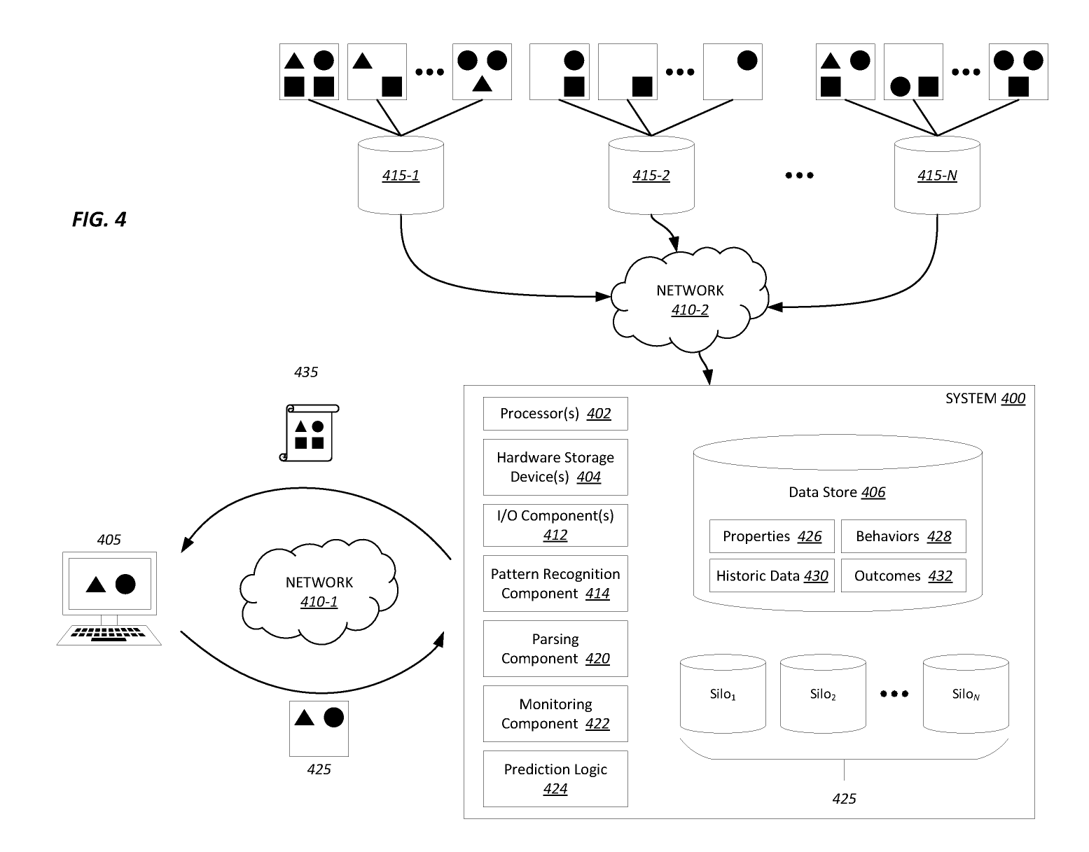

Referring now to FIG. 4, illustrated is a system 400 that is substantially similar to the system 300 of FIG. 3. The system 400 of FIG. 4 additionally includes a user 405 communicating with the system 400 over a network 410-1 to provide one or more user properties 425. The system 400 can be configured to identify any patterns within the user properties 425 using, for example, pattern recognition component 414 and information stored within data store 406. The patterns identified within user properties 425 can be processed by prediction logic 424 to determine any likelihood previously described. The pattern recognition component 414 can report and/or implement changes (represented by property changes 435) within the user 405 using, for example, I/O components 412.

In some embodiments, the system 400 reports insights to the user 405, which can include action items or other information that allow the user a higher or lower likelihood of exceeding a threshold, depending on the purpose or intent of the user (as described above). For example, a user may communicate a set of properties (e.g., as shown by user properties 425) to system 400 via network 410-1. The properties can be parsed by parsing component 420 and stored within properties database 426 of data store 406 or directly compared to properties from other users (e.g., users 415-1, 415-2, 415-N), which may be received through network 410-2 (which may be the same network as network 410-1 or may be a different network) or retrieved from previously parsed and stored user data (e.g., from user store 406). Based on the comparisons or patterns determined from the user properties 425 and the stored properties 426, the system 400 can determine a likelihood the user 405 will exceed a threshold. In response to a high likelihood of exceeding a threshold, for example, the system 400 may generate an incentive 435 (e.g., reduce average volatility of resource consumption by 5% and receive additional resource allocation). The incentive may be based, for example, on the particular system requirements and associated user resource utilization and/or demands and may be specific to each system.

In some embodiments, the incentive 435 is applied directly to the user 405. This may be, for example, forced conformation with a particular incentive to increase system 400 stability or it may, in some embodiments, be a requirement for participation in system 400.

### Methods for Characterizing User Populations

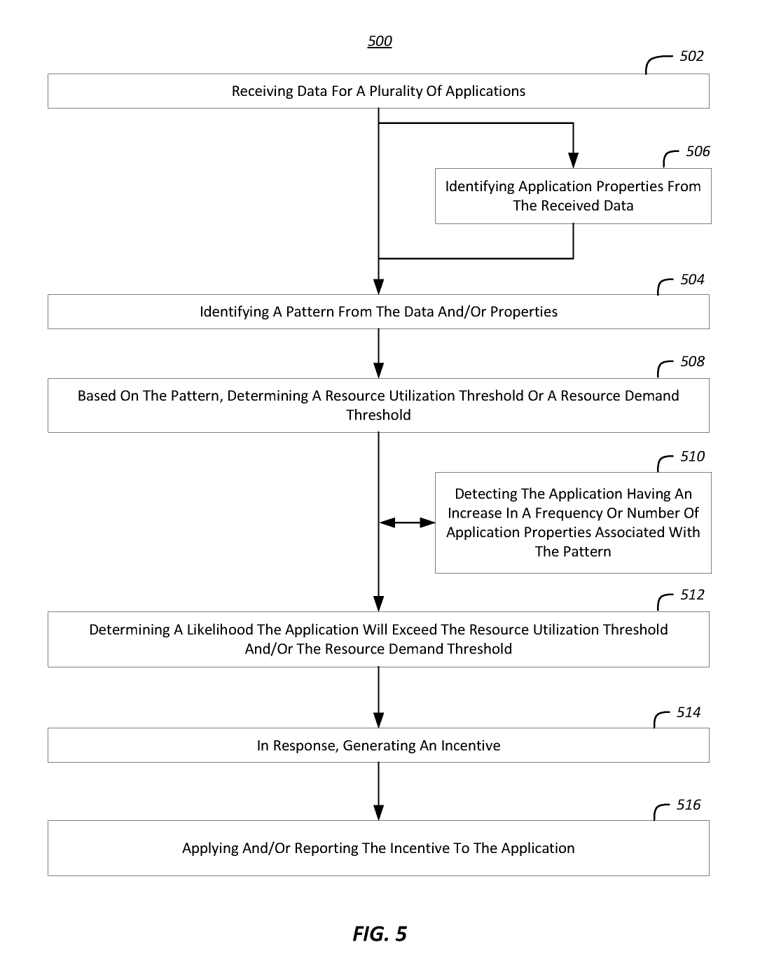

FIGS. 1-4 and the corresponding text illustrate or otherwise describe one or more systems, components, modules, mechanisms and/or graphical user interfaces related to characterizing user populations, including but not limited to identifying patterns within user populations and determining likelihoods of exceeding thresholds and for generating actions related thereto. One will appreciate that embodiments of the present invention can also be described in terms of methods comprising one or more acts for accomplishing a particular result. The methods may be implemented by a computer system including one or more processors executing computer-executable instructions stored on computer-readable media such as computer memory. In particular, the computer memory may store computer-executable instructions that when executed by one or more processors cause various functions to be performed, such as the acts recited in the embodiments. For example, FIGS. 5-7, with the corresponding text, illustrate or otherwise describe a sequence of acts in methods for characterizing user populations. The acts of FIGS. 5-7 are described below and can be practiced using the components and modules illustrated in FIGS. 1-4, where appropriate. Although the method acts may be discussed in a certain order or illustrated in a flowchart as occurring in a particular order, no particular ordering is required unless specifically stated, or required because an act is dependent on another act being completed prior to the act being performed.

FIG. 5 illustrates a flow chart of an example computer-implemented method 500 for characterizing user populations, which in some embodiments can include a method for determining a likelihood an application will exceed one or more of a resource utilization threshold or a resource demand threshold. The method 500 will be described with respect to and/or in light of the systems, components, and/or modules in one or more of FIGS. 1-4 discussed previously. This method includes a plurality of acts that are performed by a computing system that determines a likelihood an application will exceed one or more of a resource utilization threshold or a resource demand threshold. This system can be any of systems 100, 200, 300, and/or 300 illustrated in the corresponding figures. Each of these systems include at least one hardware processor (e.g, processors 102, 202, 302, 402) configured to execute computer-executable instructions and also include computer-readable storage media for storing computer-executable instructions and/or data structures (e.g., memory and/or hardware storage devices 104, 204, 304, 404).

The method 500 includes receiving data for a plurality of applications (act 502). For example, a computer-executable component 106 of computing system 100 may comprise computer-executable instructions that when executed by processor 102 receive data for a plurality of applications. The data may be stored within a data store such as the non-volatile memory 104 of system 100. Alternatively, the data can be obtained from a plurality of data stores accessed through a network (e.g, data stores 315-1, 315-2, and/or 315-N accessed through network 310) to receive data for a plurality of applications (act 502).

The disclosed methods also include identifying a pattern from the received data (act 504). In some embodiments, the act of identifying a pattern from the received data can be preceded by one or more acts that prepare or otherwise modify the data in preparation for identifying a pattern from the data (act 504). For example, the disclosed method can include identifying application properties from the received data (act 506), which can be relied on for identifying a pattern (act 504). The pattern recognition component 314 of system 300 can, for example, perform act 404.

Based on the pattern identified the data and/or application properties (e.g., as found by performing act 504), the disclosed methods can include determining a resource utilization threshold or a resource demand threshold (act 508). For example, the processor(s) 402 and/or the prediction logic 424 can perform all or part of act 508.

In some embodiments, the methods can additionally include determining a likelihood the application will exceed the resource utilization threshold and/or the resource demand threshold (act 512). This can be accomplished, for example, by one or more of prediction logic 424 or processor(s) 402. Act 512 can, in some embodiments, rely on and/or leverage detecting the application having an increase in a frequency or number of application properties associated with the pattern (act 510). The monitoring component 422 can, for example, be used to detect the application having an increase in a frequency or number of application properties.

In response to determining a likelihood the application will exceed the resource utilization threshold and/or the resource demand threshold (act 512), the methods can additionally include generating an incentive (act 514), which can be applied to the application and/or reported to a user (act 516). A processor (e.g., processor 402 of system 300) can be used to generate the incentive, and the incentive can be applied to the application and/or reported to a user using, for example, I/O components 412 and may additionally involve a network (e.g., network 410-1) for communicating the incentive, a report, and/or instructions for implementing the incentive with an application or user. In some embodiments, the processor is used to generate the incentive based on information (e.g., outcomes 432, previously successful incentives, user specific incentives, etc.) stored in a data store (e.g., data store 406 of system 300).

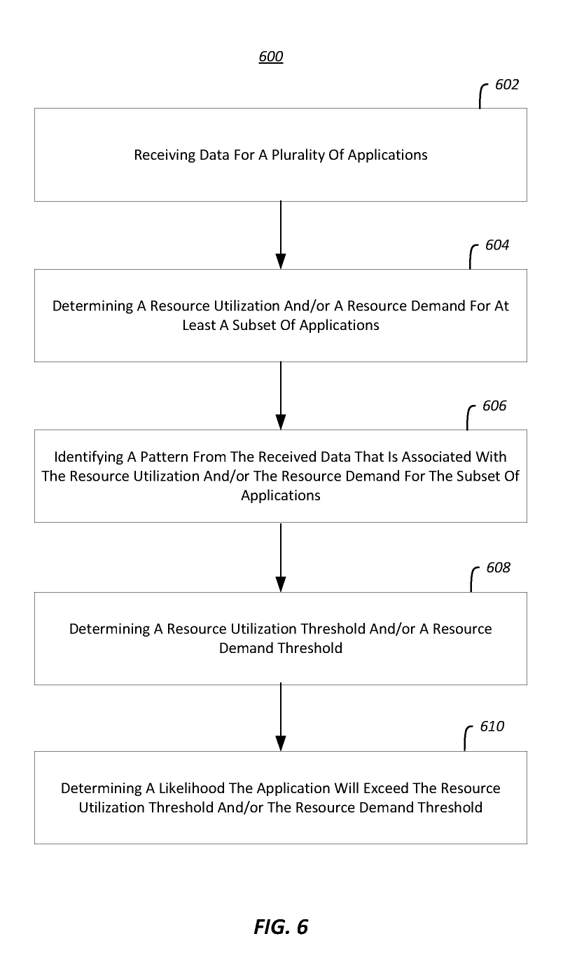

Referring now to FIG. 6, illustrated is a flowchart of an example computer implemented method for characterizing user populations, which in some embodiments includes a method 600 for determining a likelihood an application will exceed one or more of a resource utilization threshold or a resource demand threshold. As illustrated in FIG. 6, method 600 can include receiving data for a plurality of applications (act 602). Act 602 can be implemented, for example, by system 300 of FIG. 3. Particularly, act 602 can be received by processor(s) 402 and/or data store 406 through I/O component(s) 412 in communication with user 405 through network 410-1.

The method 600 can additionally include determining a resource utilization and/or a resource demand for at least a subset of applications (act 604). Act 604 can be implemented, for example, by processor(s) 402. The method 600 can additionally include identifying a pattern from the received data that is associated with the resource utilization and/or the resource demand for the subset of applications (act 606). Act 606 can be implemented in any manner known in the art in addition to, for example, the components described above with respect to act 504 of FIG. 5.

Method 600 can additionally include determining a resource utilization threshold and/or a resource demand threshold (act 608) in determining a likelihood the application will exceed the resource utilization threshold and/or the resource demand threshold (act 610). Acts 608 and 610 can be implemented, for example, in the same or similar ways described above with respect to acts 508 and 512 described above with respect to method 500 of FIG. 5.

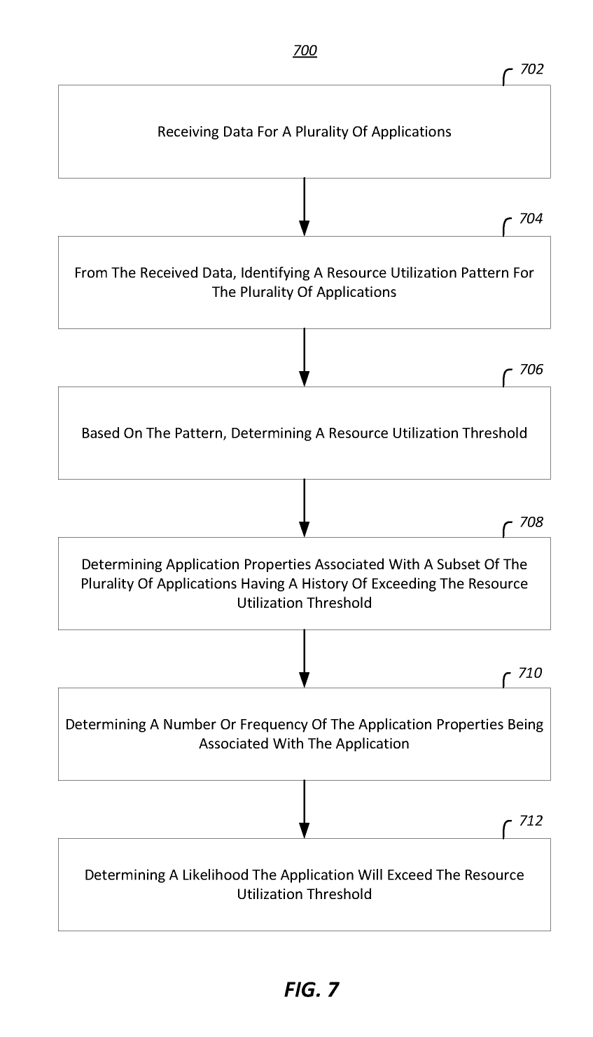

Referring now to FIG. 7, illustrated is a flow chart of an example computer-implemented method for characterizing user populations, which in some embodiments includes a method 700 for determining a likelihood an application will exceed a resource utilization threshold. As illustrated in FIG. 7, method 700 can include receiving data for a plurality of application (act 702), from the receive data, identifying a resource utilization pattern for the plurality of applications (act 704), based on the pattern determining a resource utilization threshold (act 706), determining application properties associated with a subset of the plurality of applications having a history of exceeding the resource utilization threshold (act 708), determining a number or frequency of the application properties being associated with the application (act 710), and determining a likelihood the application will exceed the resource utilization threshold (act 712). These method acts can be implemented by any means known in the art, including those described above for acts 602-610 of FIG. 6 and/or, for example, by any of processor(s) 302, pattern recognition component 314, data comparator 216, prediction logic 324, and/or can utilize any available instructions or information (e.g., computer-implemented instructions, information stored within data store 306, etc.).

Additionally, or alternatively, processor(s) 402 and/or parsing component 420 can perform at least a portion of act 708. As a specific example, properties 426 of data store 406 can be derived from users 415-1, 415-2, 415-N and accessed or queried by a user accessing the system 300 through network 410-1 using I/O component(s) 412 and/or by execution of computer-executable instructions stored on hardware storage device(s) 404 that act to query data store 406 to identify user properties 426.

### Abbreviated List of Defined Terms

To assist in understanding the scope and content of the foregoing written description and appended claims, a select few terms are defined directly below.

The term “database component” or “data component” as used herein may be used to describe a structural component of a dataset, database, or index such as, for example, an entry, a row and/or a column. The term “database component” or “data component” may also be used herein to describe other descriptive aspects of datasets, databases or indexes such as, for example, the number of rows, the number of distinct values for a column, histograms of the of the distribution of data values in a column, the number of distinct index keys, and/or the most common value(s) in a column. It should be understood that reference to “rows” and “columns,” unless specifically stated otherwise can also include their transformed counterparts. That is, through a simple transformation, rows may become columns and vice versa. As an exemplary illustration, the term “database component” or “data component” also includes the number of distinct values for a row, as the row may be transformed into columnar format and satisfy the present definition as encompassing “the number of distinct values for a column.”

As used herein, the term “database server” is broadly defined as any general purpose or special purpose computer that stores one or more databases and which supports (e.g., compiles and executes commands) one or more database languages known in the art (e.g., SQL, Datalog, Data Mining Extensions (DMX), Language Integrated Query (LINQ), XML Query (XQuery), etc.). A database server may be local or may be distributed and may be accessed through a network(s) and may include any type of database, including, for example, a relational database.

The term “user” as used herein encompasses any actor operating within a given system. The actor can be, for example, a human actor at a computing system or end terminal. In some embodiments, the user is a machine, such as an application, or components within a system. The term “user” further extends to administrators and does not, unless otherwise specified, differentiate between an actor and an administrator as users. Accordingly, any step performed by a “user” or “administrator” may be performed by either or both a user and/or an administrator. Additionally, or alternatively, any steps performed and/or commands provided by a user may also be performed/provided by an application programmed and/or operated by a user.

Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes that come within the meaning and range of equivalency of the claims are to be embraced within their scope.

What is claimed is:

1. A computer system comprising:
one or more processors; and
one or more computer-readable storage media having stored thereon computer-executable instructions that when executed by the one or more processors cause the computer system to determine a likelihood an application will exceed one or more of a resource utilization threshold or a resource demand threshold by causing the computer system to perform at least the following:
receive data for a plurality of applications;
based on the received data, determine one or more of a resource utilization or a resource demand for at least a subset of applications of the plurality of applications;
identify a pattern from the received data, the pattern being associated with one or more of the resource utilization or the resource demand for the subset of applications;
based on the pattern, determine one or more of a resource utilization threshold or a resource demand threshold; and
determine a likelihood the application will exceed one or more of the resource utilization threshold or the resource demand threshold.

2. The computer system of claim 1, wherein the resource utilization comprises one or more of: a present resource utilization, a resource utilization history, a historic maximum resource utilization, an average historic resource utilization, or a future predicted resource utilization.

3. The computer system of claim 2, wherein the resource utilization history comprises one or more of: a type of resource utilized, a resource utilization date, a resource utilization duration, a resource allocation amount, a proportion of utilized resource based on the resource allocation amount, or combinations thereof

4. The computer system of claim 1, wherein the resource demand comprises one or more of: a present resource utilization, a past resource utilization, a historic maximum resource utilization, an average historic resource utilization, or a future predicted resource utilization.

5. The computer system of claim 4, wherein the resource demand history comprises one or more of: a type of resource demanded, a resource demand date, a resource demand amount, a failed request for additional resources, a frequency of requests for additional resources, a successful request for additional resources, an age of granted additional resources, or combinations thereof.

6. The computer system of claim 1, wherein determining the likelihood the application will exceed one or more of the resource utilization threshold or the resource demand threshold comprises:
identifying one or more application properties from the received data, the one or more application properties being derived from a subset of the plurality of applications having a history of exceeding one or more of the resource utilization threshold or the resource demand threshold;
identifying one or more patterns based on the one or more application properties; and
detecting the application having an increase in a frequency or number of application properties associated with the one or more patterns.

7. The computer system of claim 6, wherein the one or more application properties comprise one or more of: a logon event, a number or frequency of received communications, a number or frequency of requested communications, or a combination thereof

8. The computer system of claim 6, wherein the one or more application properties comprise a resource utilization history or a resource demand history for any of the plurality of applications.

9. The computer system of claim 6, wherein the computer system further includes computer executable instructions that when executed cause the computer system to generate an incentive in response to detecting the application having the increase in the frequency or number of application properties associated with the one or more patterns.

10. The computer system of any one of claims 9, wherein the computer system further includes computer executable instructions that when executed cause the computer system to apply the incentive to the application.

11. The computer system of claim 10, wherein the computer system further includes computer executable instructions that when executed cause the computer system to report the incentive to a user.

12. A computer-implemented method for determining a likelihood an application will exceed one or more of a resource utilization threshold or a resource demand threshold, the method comprising:
receiving data for a plurality of applications;
based on the received data, determining one or more of a resource utilization or a resource demand for at least a subset of applications of the plurality of applications;
identifying a pattern from the received data, the pattern being associated with one or more of the resource utilization or the resource demand for the subset of applications;
based on the pattern, determining one or more of a resource utilization threshold or a resource demand threshold; and
determining a likelihood the application will exceed one or more of the resource utilization threshold or the resource demand threshold.

13. The method of claim 12, wherein determining the likelihood the application will exceed one or more of the resource utilization threshold or the resource demand threshold comprises:
identifying one or more application properties from the received data, the one or more application properties being derived from a subset of the plurality of applications having a history of exceeding one or more of the resource utilization threshold or the resource demand threshold;
identifying one or more patterns based on the one or more application properties; and
detecting the application having an increase in a frequency or number of application properties associated with the one or more patterns.

14. The method of claim 13, wherein the one or more application properties comprise one or more of: a logon event, a number or frequency of received communications, a number or frequency of requested communications, or a combination thereof.

15. The method of claim 13, wherein the method further comprises generating an incentive in response to detecting the application having the increase in the frequency or number of application properties associated with the one or more patterns.

16. The method of claim 15, wherein the method further comprises applying the incentive to the application.

17. The method of claim 16, wherein the computer system further includes computer executable instructions that when executed cause the computer system to report the incentive to a user.

18. The method of claim 12, wherein the resource utilization comprises one or more of: a present resource utilization, a resource utilization history, a historic maximum resource utilization, an average historic resource utilization, or a future predicted resource utilization, and wherein the resource demand comprises one or more of: a present resource utilization, a past resource utilization, a historic maximum resource utilization, an average historic resource utilization, or a future predicted resource utilization.

19. The method of claim 18, wherein the resource utilization history comprises one or more of: a type of resource utilized, a resource utilization date, a resource utilization duration, a resource allocation amount, a proportion of utilized resource based on the resource allocation amount, or combinations thereof, and wherein the resource demand history comprises one or more of: a type of resource demanded, a resource demand date, a resource demand amount, a failed request for additional resources, a frequency of requests for additional resources, a successful request for additional resources, an age of granted additional resources, or combinations thereof.

20. A computer system comprising:
one or more processors; and
one or more computer-readable storage media having stored thereon computer-executable instructions that when executed by the one or more processors cause the computer system to determine a likelihood an application will exceed a resource utilization threshold by causing the computer system to perform at least the following:
receive data for a plurality of applications;
from the received data, identify a resource utilization pattern for the plurality of applications;
based on the pattern, determine a resource utilization threshold;
determine one or more application properties associated with a subset of the plurality of applications having a history of exceeding the resource utilization threshold;
determine a number or frequency of the one or more application properties being associated with the application; and
determine a likelihood the application will exceed the resource utilization threshold.
